(19) United States
(12) Patent Application Publication
(10) Pub. No.: US 2023/0027341 A1
(43) Pub. Date: Jan. 26, 2023

(54) ROTATING ELECTRIC MACHINE AND DRIVE APPARATUS

(71) Applicant: NIDEC CORPORATION, Kyoto (JP)

(72) Inventors: Takayuki MIZUTANI, Kyoto (JP); Rinto INOUE, Kyoto (JP)

(21) Appl. No.: 17/868,816

(22) Filed: Jul. 20, 2022

(30) Foreign Application Priority Data
Jul. 21, 2021 (JP) 2021-120753

(51) Int. Cl. H02K 5/20; H02K 3/50; H02K 9/19; H02K 11/33

(52) U.S. Cl. CPC H02K 5/203; H02K 3/50; H02K 9/19; H02K 11/33; H02K 2203/09

(57) ABSTRACT

A rotating electric machine includes a rotor rotatable about an axis, a stator, and a motor housing accommodating the rotor and the stator. The motor housing includes a refrigerant channel through which the refrigerant flows, and a pair of channel ports respectively located at both end portions of the refrigerant channel. The refrigerant channel includes a meander channel extending in a wave shape along the circumferential direction, and a pair of end channels connecting an end portion of the meander channel and a channel port. At least one of the end channels includes a first circumferential channel portion extending along the circumferential direction, a second circumferential channel portion extending along the circumferential direction and overlapping the first circumferential channel portion as viewed along the axis, and an axial channel portion extending along the axial direction and connecting the first circumferential channel portion and the second circumferential channel portion.

### CROSS-REFERENCE TO RELATED APPLICATIONS

The present invention claims priority under 35 U.S.C. §119 to Japanese Patent Application No. 2021-120753 filed on Jul. 21, 2021, the entire content of which is incorporated herein by reference.

### FIELD OF THE INVENTION

The present invention relates to a rotating electric machine and a drive apparatus.

### BACKGROUND

In recent years, rotating electric machines for driving mounted on electric vehicles have been actively developed. A cooling structure is mounted on such a rotating electric machine. Conventionally, there is known a structure in which a motor is cooled by a motor case having a water passage extending in a rectangular wave shape along a circumferential direction.

In the conventional motor case, a uniform water passage is provided over the entire circumference in order to uniformly cool the entire motor. For this reason, there is a problem that it is necessary to dispose the inflow port and the outflow port of the water passage close to each other, and the relative arrangement of the inflow port and the outflow port is limited, and the degree of freedom in designing the peripheral member is limited.

### SUMMARY

One aspect of an exemplary rotating electric machine of the present invention includes a rotor configured to be rotatable about a central axis, a stator surrounding the rotor, and a motor housing accommodating the rotor and the stator. The motor housing includes a refrigerant channel through which the refrigerant flows, and a pair of channel ports respectively located at both end portions of the refrigerant channel. The refrigerant channel includes a meander channel extending in a wave shape along a circumferential direction, and a pair of end channels connecting an end portion of the meander channel and the channel port. At least one of the end channels includes a first circumferential channel portion extending along the circumferential direction, a second circumferential channel portion extending along the circumferential direction and overlapping the first circumferential channel portion as viewed in a direction of the central axis, and an axial channel portion extending along the axial direction and connecting the first circumferential channel portion and the second circumferential channel portion.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a side view of a drive apparatus according to an embodiment;

FIG. 2 is a perspective view of a refrigerant channel according to the embodiment;

FIG. 3 is a developed perspective view of the refrigerant channel according to the embodiment;

FIG. 4 is a developed perspective view of a refrigerant channel according to a first modification;

FIG. 5 is a developed perspective view of a refrigerant channel according to a second modification;

FIG. 6 is a developed perspective view of a refrigerant channel according to a third modification;

FIG. 7 is a developed perspective view of a refrigerant channel according to a fourth modification;

FIG. 8 is a developed perspective view of a refrigerant channel according to a fifth modification;

FIG. 9 is a developed perspective view of a refrigerant channel according to a sixth modification; and

FIG. 10 is a developed perspective view of a refrigerant channel according to a seventh modification.

### DETAILED DESCRIPTION

The following description will be made with a vertical direction being defined on the basis of positional relationships in the case where a drive apparatus according to embodiments is installed in a vehicle located on a horizontal road surface. That is, it is sufficient that the relative positional relationships regarding the vertical direction described in the following embodiments are satisfied at least in the case where the drive apparatus is installed in the vehicle located on the horizontal road surface.

In the drawings, an xyz coordinate system is illustrated appropriately as a three-dimensional orthogonal coordinate system. In the XYZ coordinate system, a Z-axis direction corresponds to the vertical direction. A +Z side is an upper side in the vertical direction, and a −Z side is a lower side in the vertical direction. In the following description, the upper side and the lower side in the vertical direction will be referred to simply as the “upper side” and the “lower side”, respectively.

A central axis J1 appropriately illustrated in the drawings is a virtual axis extending in a direction intersecting the vertical direction. More specifically, the central axis J1 extends in the Y-axis direction orthogonal to the vertical direction. In description below, unless otherwise particularly stated, a direction parallel to the central axis J1 is simply referred to as the “axial direction”, a radial direction about the central axis J1 is simply referred to as the “radial direction”, and a circumferential direction about the central axis J1, i.e., a direction around the central axis J1 is simply referred to as the “circumferential direction”. In the present embodiment, the +Y side corresponds to “one side in the axial direction”, and the −Y side corresponds to the “other side in the axial direction”.

An arrow θ appropriately illustrated in the drawing indicates the circumferential direction. In the following description, a side traveling counterclockwise about the central axis J1 as viewed from −Y side in the circumferential direction, that is, a side (+θ side) on which the arrow θ faces is referred to as “one side in the circumferential direction”, and a side traveling clockwise about the central axis J1 as viewed from +Y side in the circumferential direction, that is, a side (−θ side) opposite to the side on which the arrow θ faces is referred to as “the other side in the circumferential direction”.

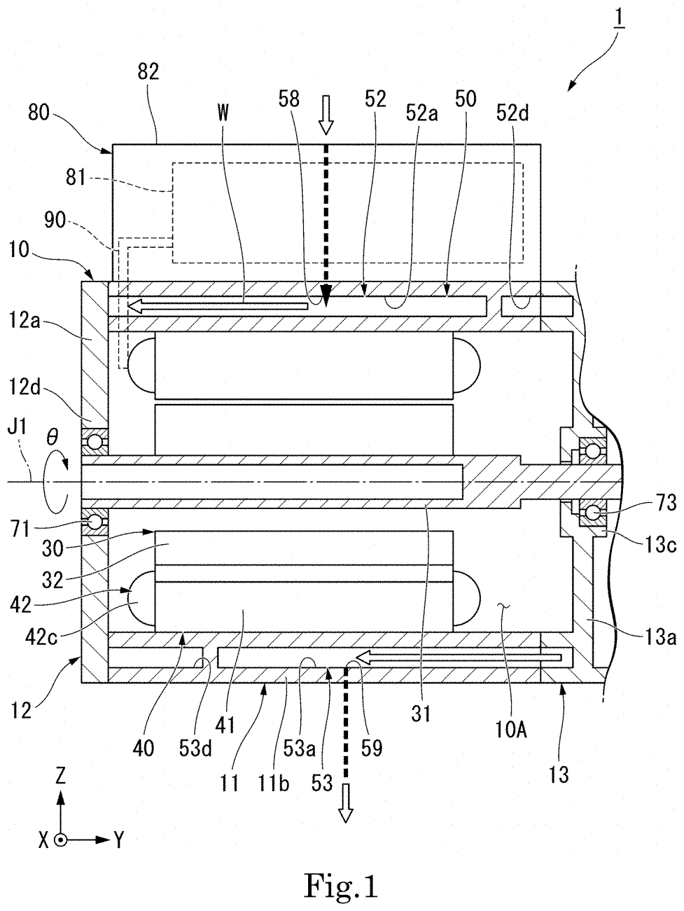

FIG. 1 is a side view of a drive apparatus 1 according to an embodiment. Note that FIG. 1 is merely a schematic diagram and does not accurately illustrate the arrangement of each unit (in particular, the shape and arrangement of a refrigerant channel 50, the shape and arrangement of channel ports 58 and 59, and the like).

The drive apparatus 1 of the present embodiment is a drive apparatus that is mounted on the vehicle and rotates an axle of the vehicle. The vehicle on which the drive apparatus 1 is mounted is a vehicle including a motor as a power source, such as a hybrid vehicle (HEV), a plug-in hybrid vehicle (PHV), or an electric vehicle (EV).

As illustrated in FIG. 1, the drive apparatus 1 includes a rotating electric machine 20, an inverter unit 80, and a bus bar 90. The rotating electric machine 20 drives the drive apparatus 1. The inverter unit 80 controls the rotating electric machine 20. The bus bar 90 connects the rotating electric machine 20 and the inverter unit 80. Note that the drive apparatus 1 may include a transmission mechanism that transmits the power of the rotating electric machine 20 to the axle of the vehicle.

The rotating electric machine 20 includes a rotor 30, a stator 40, a motor housing 10, and bearings 71 and 73. The rotor 30 is rotatable about the central axis J1 extending in the axial direction. The stator 40 encloses the rotor 30 from outside in the radial direction. A motor chamber 10A is provided inside the motor housing 10. The motor housing 10 accommodates the rotor 30 and the stator 40 in the motor chamber 10A. The bearings 71 and 73 are held by the motor housing 10 and rotatably support the rotor 30. The bearings 71 and 73 are, for example, a ball bearing.

The rotor 30 includes a shaft 31 and a rotor body 32. The shaft 31 is rotatable about the central axis J1.

The shaft 31 is centered on the central axis J1 and extends in the axial direction. The shaft 31 is accommodated in the motor chamber 10A and fixed to the rotor body 32. The shaft 31 is rotatably supported by the bearings 71 and 73.

The rotor body 32 is fixed to the outer peripheral face of the shaft 31. More specifically, the rotor body 32 is fixed to the outer peripheral face of the shaft 31. Although not illustrated, the rotor body 32 includes a rotor core, and a rotor magnet fixed to the rotor core.

The stator 40 is fixed inside the motor housing 10. The stator 40 includes a stator core 41 and a coil assembly 42. The stator core 41 has an annular shape surrounding the rotor 30. The coil assembly 42 has a plurality of coils 42c attached to the stator core 41 along the circumferential direction. The plurality of coils 42c are attached to the stator core 41 with, for example, an insulator (not illustrated) interposed between them.

The motor housing 10 includes a first housing member 11, a second housing member 12, and a third housing member 13. The first housing member 11 surrounds the stator 40 and the rotor 30 from radially outside. The second housing member 12 is located on the other side in the axial direction (−Y side) of the first housing member 11 and is fixed to the first housing member 11. The second housing member 12 is located on one side in the axial direction (+Y side) of the third housing member 13 and is fixed to the first housing member 11. Although not illustrated, the space between the first housing member 11 and the second housing member 12 in the axial direction and the space between the first housing member 11 and the third housing member 13 in the axial direction are sealed by seal members . The seal member is, for example, a metal gasket or a liquid gasket.

The first housing member 11 is a cylindrical member surrounding the rotating electric machine 20 on the radially outer side of the rotating electric machine 20. In the present embodiment, the inner peripheral face of the first housing member 11 has the cylindrical shape centered on the central axis J1. The first housing member 11 is open to the other side in the axial direction (−Y side). The stator core 41 is fitted in the first housing member 11. The first housing member 11 has a cylindrical peripheral wall portion 11b extending in the axial direction.

The second housing member 12 closes the opening on the other side in the axial direction of the first housing member 11. The second housing member 12 includes a lid portion 12a extending along a plane orthogonal to the central axis J1 and a bearing holding portion 12d provided on the lid portion 12a. The bearing holding portion 12d holds the bearing 71.

The third housing member 13 includes an opposing wall portion 13a extending along a plane orthogonal to the central axis J1 and a bearing holding portion 13c provided on the opposing wall portion 13a. The bearing holding portion 13c holds the bearing 73.

The motor housing 10 includes the refrigerant channel 50 and a pair of channel ports 58 and 59. The refrigerant channel 50 is a flow passage through which a refrigerant W such as water flows. The refrigerant is, for example, water. The pair of channel ports 58 and 59 are located at both end portions of refrigerant channel 50, respectively. One of the pair of channel ports 58 and 59 is an inflow port 58 through which the refrigerant W flows into the refrigerant channel 50, and the other is an outflow port 59 through which the refrigerant W flows out of the refrigerant channel 50.

The refrigerant channel 50 is provided in the peripheral wall portion 11b of the first housing member 11. The refrigerant channel 50 opens at both end portions in the axial direction of the peripheral wall portion 11b. The opening on one side in the axial direction (+Y side) of the refrigerant channel 50 is closed by the second housing member 12. The opening on the other side in the axial direction (−Y side) of the refrigerant channel 50 is closed by the third housing member 13.

The refrigerant W flowing through the refrigerant channel 50 is cooled by a cooling device (not illustrated). The refrigerant W flowing through the refrigerant channel 50 indirectly cools the stator 40 fixed to the motor housing 10 by cooling the motor housing 10.

The refrigerant channel 50 of the present embodiment is provided over the entire length in the axial direction of the stator 40 in the axial direction. Therefore, the refrigerant W flowing through the refrigerant channel 50 cools the motor housing 10 over the entire length in the axial direction. As a result, the refrigerant channel 50 can uniformly cool the stator 40 over the entire length in the axial direction.

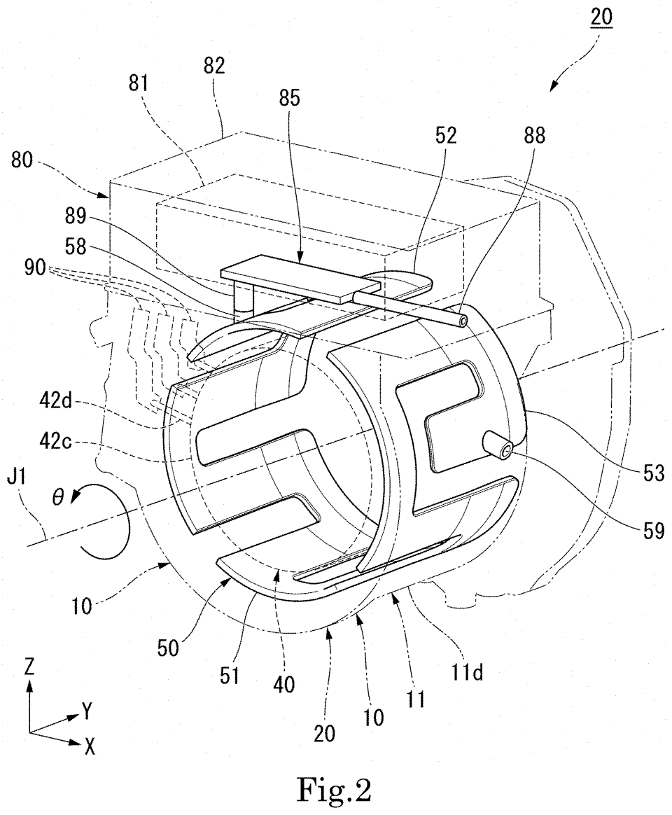

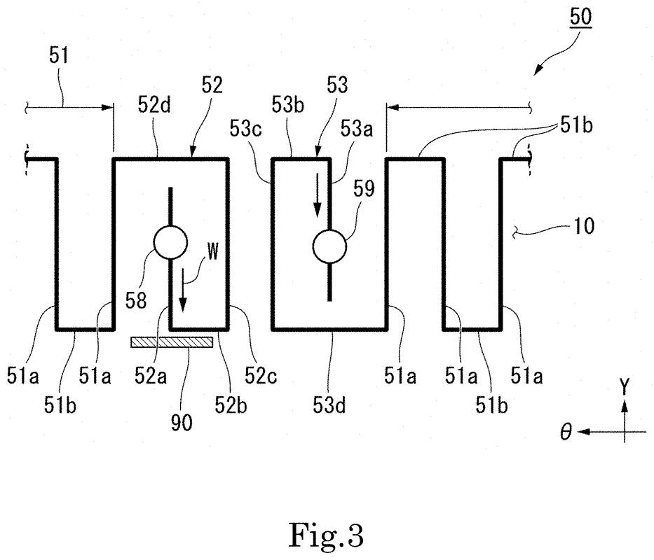

FIG. 2 is a perspective view of the refrigerant channel 50 according to the embodiment. FIG. 3 is a developed perspective view of the refrigerant channel 50 according to the embodiment. As illustrated in FIG. 2, the refrigerant channel 50 surrounds the stator 40 from the radially outer side.

As illustrated in FIG. 3, the refrigerant channel 50 includes a meander channel 51 and a pair of end channels 52 and 53. Each of the pair of end channels 52 and 53 is disposed at an end portion of the meander channel 51. The pair of end channels 52 and 53 connects the end portion of the meander channel 51 and the channel ports 58 and 59.

In the following description, when the pair of end channels 52 and 53 is distinguished, they are referred to as a first end channel 52 and a second end channel 53, respectively. The first end channel 52 is located upstream of the meander channel 51, and the second end channel 53 is located downstream of the meander channel 51. Therefore, the first end channel 52 connects the end portion of the meander channel 51 and the inflow port 58. The second end channel 53 connects the end portion of the meander channel 51 and the outflow port 59.

The meander channel 51 extends in a wave shape along the circumferential direction. The meander channel 51 is provided over the entire length in the axial direction of the stator 40. As a result, the refrigerant W flowing through the meander channel 51 cools the entire length of the stator 40 in the axial direction. The meander channel 51 of the present embodiment has a rectangular wave shape. By forming the meander channel 51 in a rectangular wave shape, it is possible to densely configure the water passage and uniformly cool the stator 40 as compared with a case where the meander channel 51 has a sinusoidal wave shape or the like. In the present specification, the rectangular wave shape is a concept including not only a case where a water passage meanders in a rectangular shape in a strict sense, but also a case where a rectangular corner portion is curved with a predetermined curvature (that is, a substantially rectangular wave shape).

The meander channel 51 includes a plurality of axial channel portions 51a extending along the axial direction and a plurality of circumferential channel portions 51b extending along the circumferential direction. The plurality of axial channel portions 51a extend in parallel to each other. The plurality of axial channel portions 51a extend at substantially equal intervals along the circumferential direction. The meander channel 51 of the present embodiment has five axial channel portions 51a. The circumferential channel portion 51b connects the axial channel portions 51a adjacent to each other in the circumferential direction. The meander channel 51 of the present embodiment has four circumferential channel portions 51b. Two of the four circumferential channel portions 51b connect the end portions on one side in the axial direction (+Y side) of the adjacent axial channel portions 51a, and the other two connect the end portions on the other side in the axial direction (−Y side) of the adjacent axial channel portions 51a.

The first end channel 52 is disposed at an end portion on the other side in the circumferential direction (−θ side) of the meander channel 51. The first end channel 52 includes a first axial channel portion 52a, a second axial channel portion (axial channel portion) 52c, a first circumferential channel portion 52b, and a second circumferential channel portion 52d. In the first end channel 52, the refrigerant W flows through the first axial channel portion 52a, the first circumferential channel portion 52b, the second axial channel portion 52c, and the second circumferential channel portion 52d in this order.

The first axial channel portion 52a and the second axial channel portion 52c extend in parallel to each other along the axial direction. The first axial channel portion 52a is disposed between the meander channel 51 and the second axial channel portion 52c. The inflow port 58 is disposed in the path of the first axial channel portion 52a. Although the inflow port 58 of the present embodiment is disposed in the middle of the first axial channel portion 52a, the inflow port 58 may be provided at the upstream end portion of the first axial channel portion 52a.

The refrigerant W flows in the first axial channel portion 52a mainly from one side in the axial direction (+Y side) toward the other side in the axial direction (−Y side). The refrigerant W flows in the second axial channel portion 52c from the other side in the axial direction (−Y side) toward one side in the axial direction (+Y side).

The channel length of the first axial channel portion 52a is shorter than the channel length of the second axial channel portion 52c. The axial positions of the end portions on the other side in the axial direction (−Y side) of the first axial channel portion 52a and the second axial channel portion 52c coincide with each other. On the other hand, the end portion on one side in the axial direction (+Y side) of the first axial channel portion 52a is located on the other side in the axial direction (−Y side) with respect to the end on one side in the axial direction (+Y side) of the second axial channel portion 52c. In the motor housing 10, the second circumferential channel portion 52d passes through a region on one side in the axial direction (+Y side) of the first axial channel portion 52a. That is, the first axial channel portion 52a and the second circumferential channel portion 52d overlap each other in the axial direction.

The first circumferential channel portion 52b and the second circumferential channel portion 52d extend along the circumferential direction. The first circumferential channel portion 52b connects the end portions on the other side in the axial direction (−Y side) of the first axial channel portion 52a and the second axial channel portion 52c. On the other hand, the second circumferential channel portion 52d connects the end portion on one side in the axial direction (+Y side) of the second axial channel portion 52c and the end of the meander channel 51.

The refrigerant W flows toward the opposite side in the circumferential direction in the first circumferential channel portion 52b and the second circumferential channel portion 52d. The refrigerant W flows from one side in the circumferential direction (+θ side) toward the other side in the circumferential direction (−θ side) in the first circumferential channel portion 52b. The refrigerant W flows from the other side in the circumferential direction (−θ side) toward one side in the circumferential direction (+θ side) in the second circumferential channel portion 52d.

The second circumferential channel portion 52d overlaps the first circumferential channel portion 52b as viewed in the direction of the central axis J1. The first circumferential channel portion 52b and the second circumferential channel portion 52d are connected by the second axial channel portion 52c. Therefore, the first circumferential channel portion 52b, the second axial channel portion 52c, and the second circumferential channel portion 52d have a shape folded back in a U shape in the first end channel 52. According to this structure, the refrigerant W changes the flow direction from the other side in the circumferential direction (−θ side) to one side in the circumferential direction (+θ side) in the first end channel 52.

The second end channel 53 is disposed at an end portion on one side in the circumferential direction (+θ side) of the meander channel 51. The second end channel 53 includes a first axial channel portion 53a, a second axial channel portion (axial channel portion) 53c, a first circumferential channel portion 53b, and a second circumferential channel portion 53d. In the second end channel 53, the refrigerant W flows through the second circumferential channel portion 53d, the second axial channel portion 53c, the first circumferential channel portion 53b, and the first axial channel portion 53a in this order.

The first axial channel portion 53a and the second axial channel portion 53c extend in parallel to each other along the axial direction. The first axial channel portion 53a is disposed between the meander channel 51 and the second axial channel portion 53c. More specifically, the first axial channel portion 53a is disposed between the meander channel 51 and the second axial channel portion 53c. The outflow port 59 is disposed in the path of the first axial channel portion 53a. Although the outflow port 59 of the present embodiment is disposed in the middle of the first axial channel portion 53a, the outflow port 59 may be provided at the downstream end portion of the first axial channel portion 53a.

The refrigerant W flows toward the opposite side in the axial direction in the first axial channel portion 53a and the second axial channel portion 53c. The refrigerant W flows in the first axial channel portion 53a mainly from one side in the axial direction (+Y side) toward the other side in the axial direction (−Y side). The refrigerant W flows in the second axial channel portion 53c from the other side in the axial direction (−Y side) toward one side in the axial direction (+Y side).

The channel length of the first axial channel portion 53a is shorter than the channel length of the second axial channel portion 53c. The axial positions of the end portions on one side in the axial direction (+Y side) of the first axial channel portion 53a and the second axial channel portion 53c coincide with each other. On the other hand, the end portion on the other side in the axial direction (−Y side) of the first axial channel portion 53a is located on one side in the axial direction (+Y side) with respect to the end portion on the other side in the axial direction (−Y side) of the second axial channel portion 53c. In the motor housing 10, the second circumferential channel portion 53d passes through a region on the other side in the axial direction (−Y side) of the first axial channel portion 53a. That is, the first axial channel portion 53a and the second circumferential channel portion 53d overlap each other in the axial direction.

The first circumferential channel portion 53b and the second circumferential channel portion 53d extend along the circumferential direction. The first circumferential channel portion 53b connects the end portions on one side in the axial direction (+Y side) of the first axial channel portion 53a and the second axial channel portion 53c. On the other hand, the second circumferential channel portion 53d connects the end portion on the other side in the axial direction (−Y side) of the second axial channel portion 53c and the end of the meander channel 51.

The refrigerant W flows in the first circumferential channel portion 53b from one side in the circumferential direction (+θ side) toward the other side in the circumferential direction (−θ side). The refrigerant W flows in the second circumferential channel portion 53d from the other side in the circumferential direction (−θ side) toward one side in the circumferential direction (+θ side).

The second circumferential channel portion 53d overlaps the first circumferential channel portion 53b as viewed in the direction of the central axis J1. The first circumferential channel portion 53b and the second circumferential channel portion 53d are connected by the second axial channel portion 53c. Therefore, the first circumferential channel portion 53b, the second axial channel portion 53c, and the second circumferential channel portion 53d have a shape folded back in a U shape in the second end channel 53. According to this structure, the refrigerant W changes the flow direction from one side in the circumferential direction (+θ side) to the other side in the circumferential direction (−θ side) in the second end channel 53.

In the present embodiment, the meander channel 51 is provided with five axial channel portions 51a, and the first end channel 52 and the second end channel 53 are provided with two axial channel portions 52a and 52c, and 53a and 53c, respectively. That is, the refrigerant channel 50 is provided with nine axial channel portions 51a, 52a, 52c, 53a, and 53c. All the axial channel portions 51a, 52a, 52c, 53a, and 53c are arranged side by side at equal intervals along the circumferential direction. Therefore, the refrigerant channel 50 of the present embodiment can uniformly cool the stator 40 along the circumferential direction.

In the present embodiment, the first end channel 52 includes the first circumferential channel portion 52b, the second axial channel portion 52c, and the second circumferential channel portion 52d that are folded back in a U shape in the circumferential direction around the inflow port 58. Similarly, the second end channel 53 includes the first circumferential channel portion 53b, the second axial channel portion 53c, and the second circumferential channel portion 53d that are folded back in a U shape in the circumferential direction around the outflow port 59. Therefore, flow passages surrounding the channel ports 58 and 59 are provided around the channel ports (the inflow port 58 and the outflow port 59). According to the present embodiment, regardless of the arrangement of the channel ports 58 and 59, the peripheries of the channel ports 58 and 59 can be uniformly cooled by the flow passage surrounding the inflow ports 58 and 59. Therefore, according to the present embodiment, it is possible to uniformly cool the stator 40 around the channel ports 58 and 59 while securing the degree of freedom in arrangement of the channel ports 58 and 59.

In the present embodiment, the second axial channel portion 52c and the second axial channel portion 53c are disposed between the pair of channel ports 58 and 59 in the circumferential direction. According to the present embodiment, even when the pair of channel ports 58 and 59 is separated in the circumferential direction, the refrigerant W can be caused to flow and be cooled by the second axial channel portion 52c and the second axial channel portion 53c in the region between the channel ports 58 and 59. As a result, the stator 40 can be uniformly cooled in the circumferential direction regardless of the arrangement of the channel ports 58 and 59.

In the present embodiment, both of the pair of end channels 52 and 53 are formed in a U-shape folded back in the circumferential direction. That is, both of the pair of end channels 52 and 53 of the present embodiment have the first circumferential channel portions 52b and 53b, the second circumferential channel portions 52d and 53d, and the second axial channel portions 52c and 53c. Therefore, flow passages surrounding the channel ports 58 and 59 are provided around the two channel ports 58 and 59, respectively, and the degree of freedom in arrangement of the respective channel ports 58 and 59 is increased. In addition, since the two second axial channel portions 52c and 53c are disposed between the pair of channel ports 58 and 59, the stator 40 can be uniformly cooled when the pair of channel ports 58 and 59 is largely separated.

In the present embodiment, a case where both the end channels have the first circumferential channel portions 52b and 53b, the second circumferential channel portions 52d and 53d, and the axial channel portions 52c and 53c, respectively, has been described. However, if at least one of the end channels 52 and 53 has these, the above-described certain effects can be obtained.

According to the present embodiment, the inflow port 58 is disposed between the first circumferential channel portion 52b and the second circumferential channel portion 52d in the central axis J1 direction. Similarly, in the direction of the central axis J1, the outflow port 59 is disposed between the first circumferential channel portion 53b and the second circumferential channel portion 53d. According to the present embodiment, since the flow passages are provided on both axial sides of the channel ports 58 and 59, respectively, the flow passages can be easily arranged around the channel ports 58 and 59 without any gap, and the stator 40 can be uniformly cooled.

As illustrated in FIG. 1, the inverter unit 80 includes an inverter 81 and an inverter housing 82 that houses the inverter 81. That is, the drive apparatus 1 includes the inverter 81 and the inverter housing 82. The inverter 81 converts a direct current of a battery (not illustrated) into an alternating current. The inverter 81 is connected to the stator 40 via the bus bar 90. The alternating current converted by the inverter 81 is supplied to the stator 40 via the bus bar 90. That is, the inverter 81 converts a direct current supplied from the battery into an alternating current and supplies the alternating current to the stator 40.

As illustrated in FIG. 2, the inverter housing 82 is disposed above the motor housing 10. The inverter housing 82 is provided on the radially outer side of the motor housing 10 when viewed from the central axis J1 direction. The inverter housing 82 is fixed to the peripheral wall portion 11b of the first housing member 11.

The inverter housing 82 includes an inverter refrigerant channel 85, an inverter inflow port 88, and an inverter outflow port 89. That is, the inverter housing 82 is provided with the inverter refrigerant channel 85, the inverter inflow port 88, and the inverter outflow port 89.

The refrigerant W flows through the inverter refrigerant channel 85. The refrigerant W passing through the inverter refrigerant channel 85 flows in the vicinity of the inverter 81. As a result, the refrigerant W cools the inverter 81.

The inverter inflow port 88 is located at an upstream end portion of the inverter refrigerant channel 85. On the other hand, the inverter outflow port 89 is located at a downstream end portion of the inverter refrigerant channel 85. The inverter outflow port 89 is connected to the inflow port 58 of the refrigerant channel 50. The refrigerant W flows into the inverter refrigerant channel 85 from the inverter inflow port 88, further flows into the refrigerant channel 50 via the inverter outflow port 89 and the inflow port 58, and flows out at the outflow port 59. In this manner, the refrigerant W sequentially cools the inverter 81 and the stator 40.

According to the present embodiment, one of the pair of channel ports 58 and 59 (specifically, the inflow port 58) is connected to the inverter refrigerant channel 85 provided in the inverter housing 82. The inverter refrigerant channel 85 and the refrigerant channel 50 are directly connected without interposing a pipe or the like therebetween. According to the present embodiment, the number of components constituting the rotating electric machine 20 can be reduced as compared with a case where a pipe is interposed between the inverter refrigerant channel 85 and the refrigerant channel 50. Further, according to the present embodiment, the channel length of the entire flow passage through which the refrigerant W flows can be shortened, and the pipeline resistance of the entire flow passage of the refrigerant W can be reduced.

According to the present embodiment, the refrigerant channel 50 is disposed on the downstream side of the inverter refrigerant channel 85. Therefore, the refrigerant W cools the stator 40 after cooling the inverter 81. In general, the inverter 81 is likely to generate heat more rapidly than the stator 40. According to the present embodiment, the inverter 81 can be cooled by the refrigerant W using the low-temperature refrigerant cooled by the cooling device (not illustrated), and a rapid temperature rise of the inverter 81 can be suppressed.

In the present embodiment, one channel port (specifically, the inflow port 58) of the pair of channel ports 58 and 59 overlaps the inverter housing 82 in the radial direction. According to the present embodiment, the distance between the inflow port 58 and the inverter refrigerant channel 85 can be shortened, and the refrigerant channel 50 and the inverter refrigerant channel 85 can be connected at the shortest distance.

On the other hand, the other channel port (specifically, the outflow port 59) of the pair of channel ports 58 and 59 is disposed to be shifted from the inverter housing 82 in the circumferential direction. A pipe connected to a cooling device (not illustrated) of the refrigerant W and the like is connected to the outflow port 59. According to the present embodiment, since the outflow port 59 is disposed to be shifted from the inverter housing 82 in the circumferential direction, it is possible to prevent the pipe connected to the outflow port 59 from interfering with the inverter housing 82. In addition, as compared with a case where a largely curved pipe or the like is used as the pipe connected to the outflow port 59 for the purpose of avoiding interference with the inverter housing 82, it is possible to suppress the pipeline resistance of the entire flow passage. Further, according to the present embodiment, the degree of freedom in the configuration of the pipe connected to the channel port 58 is increased, and the degree of freedom in designing the path through which the refrigerant W circulates can be increased.

In the present embodiment, the bus bar 90 electrically connects the stator 40 and the inverter unit 80. In the present embodiment, three bus bars 90 are provided in the drive apparatus 1 corresponding to the U-phase, V-phase, and W-phase coils 42c of the stator 40. The bus bar 90 extends along the vertical direction. The bus bar 90 is made of a metal material having low electric resistivity such as a copper alloy. The bus bar 90 has a plate shape along a plane orthogonal to the central axis J1.

In the present embodiment, at least a part of the first end channel 52 connected to the inflow port 58 and the bus bar 90 overlap each other in the axial direction. A large current for driving the rotating electric machine 20 flows through the bus bar 90. Therefore, the bus bar 90 easily generates heat when the rotating electric machine 20 is driven. According to the present embodiment, the refrigerant W flows in the vicinity of the bus bar 90 and a lead wire 42d of the coil 42c connected to the bus bar 90 immediately after flowing into the refrigerant channel 50. According to the present embodiment, the low-temperature refrigerant W immediately after flowing into the refrigerant channel 50 can cool the bus bar 90 and the lead wire 42d of the coil 42c. Furthermore, according to the present embodiment, it is possible to suppress heat from being transferred, via the bus bar 90, to the electronic component to which the bus bar 90 is connected.

Hereinafter, refrigerant channels according to modifications that can be employed in the above-described embodiment will be described. Note that, in each modification, the same reference numerals are given to constituent elements of the same aspects as those of the above-described embodiment, and the description thereof will be omitted.

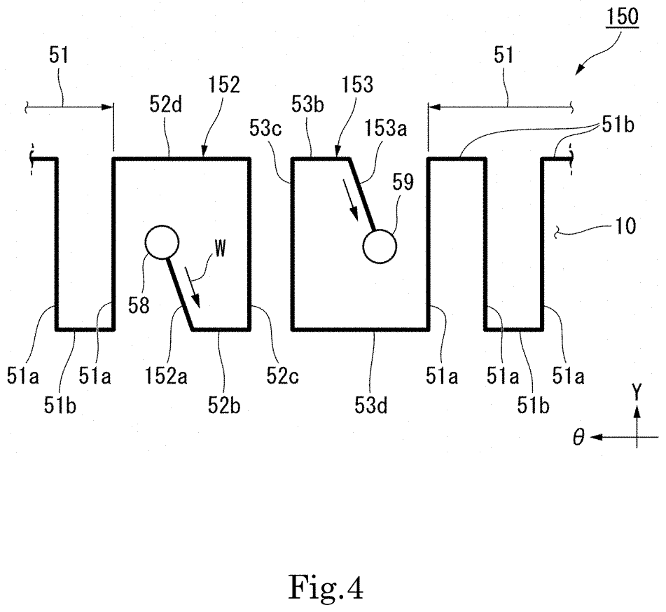

FIG. 4 is a developed perspective view of a refrigerant channel 150 according to a first modification.

As in the above-described embodiment, the refrigerant channel 150 of the present modification includes the meander channel 51 and a pair of end channels 152 and 153.

The first end channel 152 includes a first axial channel portion 152a, the second axial channel portion 52c, the first circumferential channel portion 52b, and the second circumferential channel portion 52d. Similarly, the second end channel 153 includes a first axial channel portion 153a, the second axial channel portion 53c, the first circumferential channel portion 53b, and the second circumferential channel portion 53d. In the present modification, the inflow port 58 is disposed at the end portion on one side in the axial direction (+Y side) of the first axial channel portion 152a. Similarly, the outflow port 59 is disposed at the end portion on the other side in the axial direction (−Y side) of the first axial channel portion 153a.

The first axial channel portions 152a and 153a of the present modification extend along a direction inclined in the circumferential direction with respect to the axial direction. Each of the first axial channel portions 152a and 153a of the present modification is inclined to one side in the circumferential direction (+θ side) toward one side in the axial direction (+Y side).

According to the present modification, as in the above-described embodiment, the end channels 152 and 153 include the first circumferential channel portions 52b and 53b, the second circumferential channel portions 52d and 53d, and the second axial channel portions 52c and 53c. Therefore, it is possible to uniformly cool the stator 40 around the channel ports 58 and 59 while securing the degree of freedom in arrangement of the channel ports 58 and 59.

In addition, according to the present modification, as in the above-described embodiment, since both of the pair of end channels 152 and 153 have the first circumferential channel portions 52b and 53b, the second circumferential channel portions 52d and 53d, and the second axial channel portions 52c and 53c, the degree of freedom in arrangement of the respective channel ports 58 and 59 is increased.

According to the present modification, as in the above-described embodiment, since the second axial channel portion 52c and the second axial channel portion 53c are disposed between the pair of channel ports 58 and 59 in the circumferential direction, even if the pair of channel ports 58 and 59 is separated in the circumferential direction, the flow passage can be disposed without a gap, and the stator 40 can be uniformly cooled.

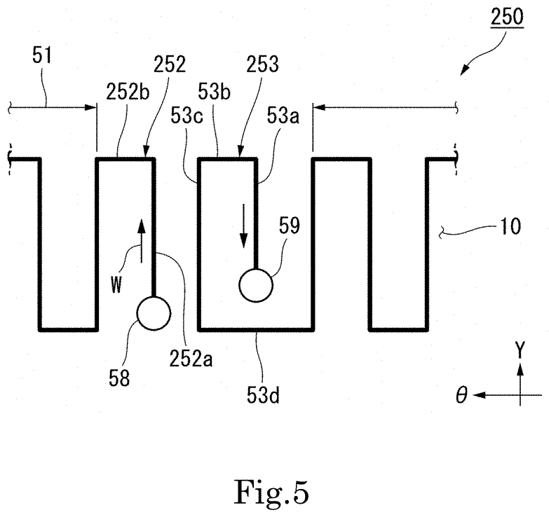

FIG. 5 is a developed perspective view of a refrigerant channel 250 according to a second modification.

The refrigerant channel 250 of the present modification includes the meander channel 51 and a pair of end channels 252 and 253 as in the above-described embodiment.

The first end channel 252 has a circumferential channel portion 252b and an axial channel portion 252a. The circumferential channel portion 252b extends from the end portion on the other side in the circumferential direction (−θ side) of the meander channel 51 to the other side in the circumferential direction. The axial channel portion 252a extends from the end portion on the other side in the circumferential direction (−θ side) of the circumferential channel portion 252b to the other side in the axial direction (−Y side).

As in the above-described embodiment, the second end channel 253 includes the first axial channel portion 53a, the second axial channel portion 53c, the first circumferential channel portion 53b, and the second circumferential channel portion 53d. The outflow port 59 is disposed at the end portion on the other side in the axial direction (−Y side) of the first axial channel portion 53a.

According to the present modification, as in the above-described embodiment, the second end channel 253 includes the first circumferential channel portion 53b, the second circumferential channel portion 53d, and the second axial channel portion 53c. Therefore, it is possible to uniformly cool the stator 40 around the outflow port 59 while securing the degree of freedom in arrangement of the outflow port 59.

According to the present modification, as in the above-described embodiment, since the second axial channel portion 53c is disposed between the pair of channel ports 58 and 59 in the circumferential direction, even if the pair of channel ports 58 and 59 is separated in the circumferential direction, the flow passage can be disposed without a gap, and the stator 40 can be uniformly cooled.

According to the present modification, as in the above-described embodiment, since the outflow port 59 is disposed between the first circumferential channel portion 53b and the second circumferential channel portion 53d in the central axis J1 direction, it is easy to dispose the flow passage around the outflow port 59 without a gap.

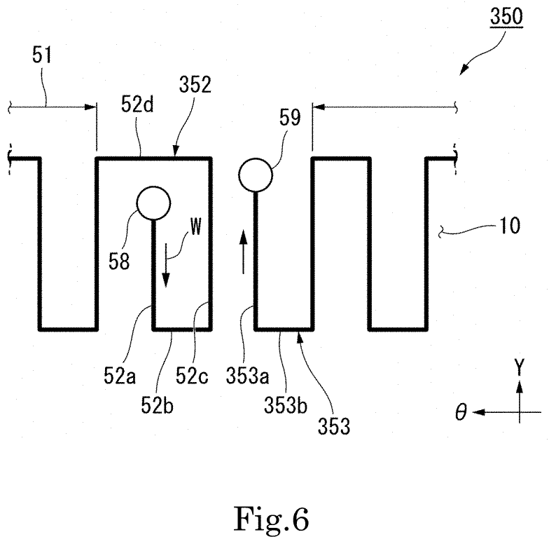

FIG. 6 is a developed perspective view of a refrigerant channel 350 according to a third modification.

The refrigerant channel 350 of the third modification has a configuration similar to that of the refrigerant channel 250 of the second modification. The refrigerant channel 350 of the third modification has a structure in which the first end channel and the second end channel of the refrigerant channel 250 of the second modification are opposite to each other. Therefore, the operation and effect of the refrigerant channel 350 of the third modification are similar to the operation and effect of the refrigerant channel 250 of the second modification.

As in the above-described embodiment, the refrigerant channel 350 of the present modification includes the meander channel 51 and a pair of end channels 352 and 353.

As in the above-described embodiment, the first end channel 352 includes the first axial channel portion 52a, the second axial channel portion 52c, the first circumferential channel portion 52b, and the second circumferential channel portion 52d. The second end channel 353 has a circumferential channel portion 353b and an axial channel portion 353a. The circumferential channel portion 353b extends to one side in the circumferential direction from the end portion on one side in the circumferential direction (+θ side) of the meander channel 51. The axial channel portion 353a extends from the end portion on one side in the circumferential direction (+θ side) of the circumferential channel portion 353b to one side in the axial direction (+Y side).

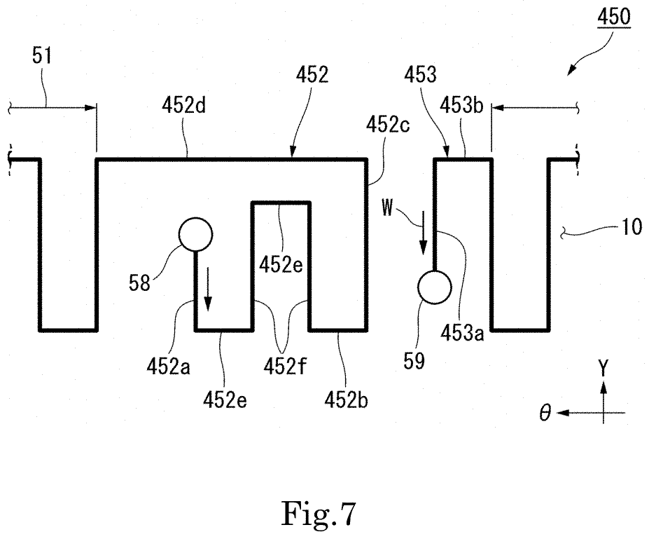

FIG. 7 is a developed perspective view of a refrigerant channel 450 according to a fourth modification.

As in the above-described embodiment, the refrigerant channel 450 of the present modification includes the meander channel 51 and a pair of end channels 452 and 453.

The first end channel 452 includes a first axial channel portion 452a, a second axial channel portion (axial channel portion) 452c, two third axial channel portions 452f, a first circumferential channel portion 452b, a second circumferential channel portion 452d, and two third circumferential channel portions 452e. In the first end channel 452, the refrigerant W flows through the first axial channel portion 452a, the third circumferential channel portion 452e, the third axial channel portion 452f, the third circumferential channel portion 452e, the third axial channel portion 452f, the first circumferential channel portion 452b, the second axial channel portion 452c, and the second circumferential channel portion 452d in this order.

The inflow port 58 is disposed in the path of the first axial channel portion 452a. The two third axial channel portions 452f and the two third circumferential channel portions 452e meander between the first axial channel portion 452a and the first circumferential channel portion 452b and extend in the circumferential direction. The first circumferential channel portion 452b and the second circumferential channel portion 452d extend along the circumferential direction. The second circumferential channel portion 452d overlaps the first circumferential channel portion 452b as viewed in the direction of the central axis J1. The first circumferential channel portion 452b and the second circumferential channel portion 452d are connected by the second axial channel portion 452c. Therefore, the first circumferential channel portion 452b, the second axial channel portion 452c, and the second circumferential channel portion 452d are configured in a U shape that changes the flow direction from the other side in the circumferential direction (−θ side) to one side in the circumferential direction (+θ side).

The second end channel 453 has a circumferential channel portion 453b and an axial channel portion 453a. The circumferential channel portion 453b extends to one side in the circumferential direction from the end portion on one side in the circumferential direction (+θ side) of the meander channel 51. The axial channel portion 453a extends from the end portion on one side in the circumferential direction (+θ side) of the circumferential channel portion 453b to the other side in the axial direction (−Y side).

According to the present modification, as in the above-described embodiment, the first end channel 452 includes the first circumferential channel portion 452b, the second circumferential channel portion 452d, and the second axial channel portion 452c. Therefore, it is possible to uniformly cool the stator 40 around the inflow port 58 while securing the degree of freedom in arrangement of the inflow port 58.

According to the present modification, as in the above-described embodiment, since the second axial channel portion 452c and the two third axial channel portions 452f are disposed between the pair of channel ports 58 and 59 in the circumferential direction, even if the pair of channel ports 58 and 59 is separated in the circumferential direction, the flow passage can be disposed without a gap, and the stator 40 can be uniformly cooled.

According to the present modification, as in the above-described embodiment, since the inflow port 58 is disposed between the first circumferential channel portion 452b and the second circumferential channel portion 452d in the central axis J1 direction, it is easy to dispose the flow passage around the inflow port 58 without a gap.

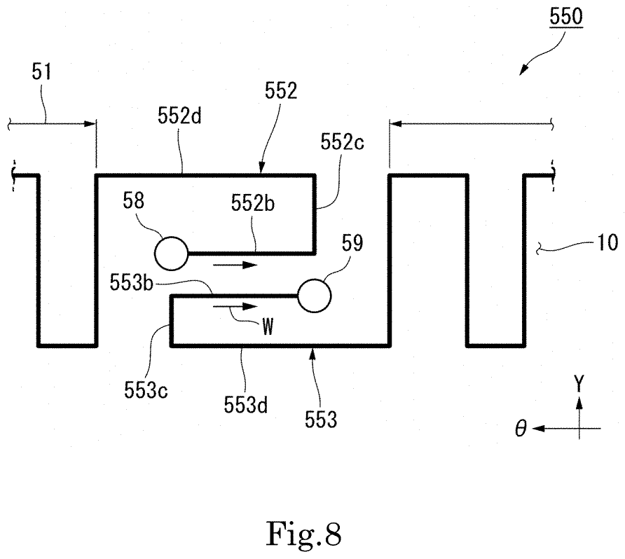

FIG. 8 is a developed perspective view of a refrigerant channel 550 according to a fifth modification.

As in the above-described embodiment, the refrigerant channel 550 of the present modification includes a meander channel 51 and a pair of end channels 552 and 553. In the present modification, the first end channel 552 and the second end channel 553 are disposed to overlap each other in the axial direction.

The first end channel 552 includes an axial channel portion 552c, a first circumferential channel portion 552b, and a second circumferential channel portion 552d. In the first end channel 552, the refrigerant W flows through the first circumferential channel portion 552b, the axial channel portion 552c, and the second circumferential channel portion 552d in this order.

The inflow port 58 is disposed in the path of the first circumferential channel portion 552b. The first circumferential channel portion 552b and the second circumferential channel portion 552d extend along the circumferential direction. The second circumferential channel portion 552d overlaps the first circumferential channel portion 552b as viewed in the direction of the central axis J1. The first circumferential channel portion 552b and the second circumferential channel portion 552d are connected by an axial channel portion 552c. Therefore, the first circumferential channel portion 552b, the axial channel portion 552c, and the second circumferential channel portion 552d are formed in a U shape that changes the flow direction from the other side in the circumferential direction (−θ side) to one side in the circumferential direction (+θ side).

The second end channel 553 includes an axial channel portion 553c, a first circumferential channel portion 553b, and a second circumferential channel portion 553d. In the second end channel 553, the refrigerant W flows through the second circumferential channel portion 553d, the first circumferential channel portion 553b, and the axial channel portion 553c in this order.

The outflow port 59 is disposed in the path of the first circumferential channel portion 553b. The first circumferential channel portion 553b and the second circumferential channel portion 553d extend along the circumferential direction. The second circumferential channel portion 553d overlaps the first circumferential channel portion 553b as viewed in the direction of the central axis J1. The first circumferential channel portion 553b and the second circumferential channel portion 553d are connected by the axial channel portion 553c. Therefore, the first circumferential channel portion 553b, the axial channel portion 553c, and the second circumferential channel portion 553d are configured in a U shape that changes the flow direction from one side in the circumferential direction (+θ side) to the other side in the circumferential direction (−θ side).

According to the present modification, as in the above-described embodiment, the pair of end channels 552 and 553 includes the first circumferential channel portions 552b and 553b, the second circumferential channel portions 552d and 553d, and the axial channel portions 552c and 553d, respectively. Therefore, it is possible to uniformly cool the stator 40 around the inflow port 58 and the outflow port 59 while securing the degree of freedom in arrangement of the inflow port 58 and the outflow port 59.

In the refrigerant channel 550 of the present modification, the four circumferential channel portions 552b, 552d, 553b, and 553d of the pair of end channels 552 and 553 are disposed to overlap each other in the axial direction. As a result, the plurality of circumferential channel portions 552b, 552d, 553b, and 553d can be disposed in parallel around the channel ports 58 and 59, and the peripheries of the channel ports 58 and 59 can be uniformly cooled. In addition, even if the pair of end channels 552 and 553 are largely separated from each other in the circumferential direction, it is possible to uniformly cool the peripheries of the end channels 552 and 553 by disposing the circumferential channel portion between the pair of end channels 552 and 553.

According to the present modification, the inflow port 58 is disposed in the path of the first circumferential channel portion 552b extending in the circumferential direction. Therefore, when the refrigerant W flows into the refrigerant channel 550 along the circumferential direction, such as when a pipe or the like connected to the inflow port 58 extends in the circumferential direction, the refrigerant W can smoothly flow in the refrigerant channel 550. Similarly, according to the present modification, the outflow port 59 is disposed in the path of the first circumferential channel portion 553b extending in the circumferential direction. Therefore, when a pipe or the like connected to the outflow port 59 extends in the circumferential direction, the refrigerant W can be smoothly discharged from the outflow port 59 in the circumferential direction.

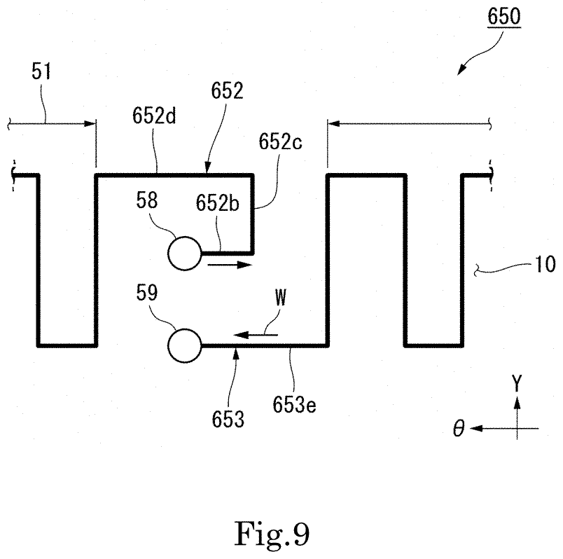

FIG. 9 is a developed perspective view of a refrigerant channel 650 according to a sixth modification.

The refrigerant channel 650 of the present modification includes the meander channel 51 and a pair of end channels 652 and 653 as in the above-described embodiment. In the present modification, the first end channel 652 and the second end channel 653 are disposed to overlap each other in the axial direction.

The first end channel 652 includes an axial channel portion 652c, a first circumferential channel portion 652b, and a second circumferential channel portion 652d. In the first end channel 652, the refrigerant W flows through the first circumferential channel portion 652b, the axial channel portion 652c, and the second circumferential channel portion 652d in this order.

The inflow port 58 is disposed in the path of the first circumferential channel portion 652b. The first circumferential channel portion 652b and the second circumferential channel portion 652d extend along the circumferential direction. The second circumferential channel portion 652d overlaps the first circumferential channel portion 652b as viewed in the direction of the central axis J1. The first circumferential channel portion 652b and the second circumferential channel portion 652d are connected by the axial channel portion 652c. Therefore, the first circumferential channel portion 652b, the axial channel portion 652c, and the second circumferential channel portion 652d are formed in a U shape that changes the flow direction from the other side in the circumferential direction (−θ side) to one side in the circumferential direction (+θ side).

The second end channel 653 includes a circumferential channel portion 653e extending from one side in the circumferential direction (+θ side) of the meander channel 51 to one side in the circumferential direction. The outflow port 59 is disposed in the path of the circumferential channel portion 653e.

According to the present modification, as in the above-described embodiment, the first end channel 652 includes the first circumferential channel portion 652b, the second circumferential channel portion 652d, and the axial channel portion 652c. Therefore, it is possible to uniformly cool the stator 40 around the inflow port 58 while securing the degree of freedom in arrangement of the inflow port 58.

In the refrigerant channel 650 of the present modification, the three circumferential channel portions 652b, 652d, and 653e of the pair of end channels 652 and 653 are disposed to overlap each other in the axial direction. That is, according to the present modification, the plurality of circumferential channel portions 652b, 652d, and 653e can be disposed in parallel around the channel ports 58 and 59, and the peripheries of the channel ports 58 and 59 can be uniformly cooled.

According to the present modification, the inflow port 58 and the outflow port 59 are disposed in the paths of the circumferential channel portions 652b and 653e, respectively. Therefore, the refrigerant W can smoothly flow in the circumferential direction at the inflow port 58 and the outflow port 59.

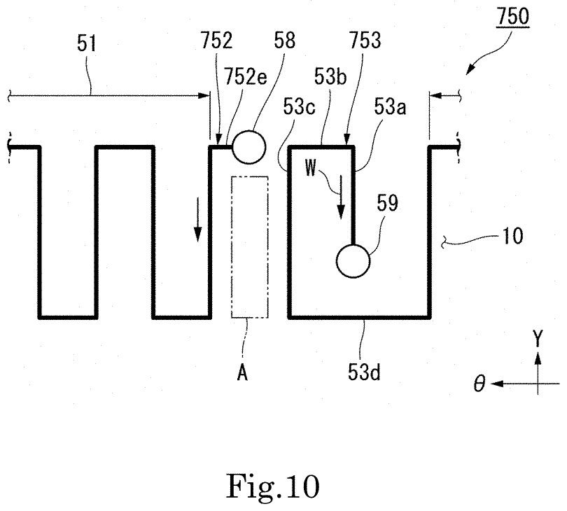

FIG. 10 is a developed perspective view of a refrigerant channel 750 according to a seventh modification.

The refrigerant channel 750 of the present modification includes the meander channel 51 and a pair of end channels 752 and 753 as in the above-described embodiment.

The first end channel 752 (the other end channel) has a circumferential channel portion (third circumferential channel portion) 752e extending from the other side in the circumferential direction (−θ side) of the meander channel 51 to the other side in the circumferential direction. The inflow port 58 is disposed in the path of the circumferential channel portion 752e. That is, the circumferential channel portion 752e directly connects the outflow port 59 and the end portion of the meander channel 51.

As in the above-described embodiment, the second end channel 753 (one of end channels) includes the first axial channel portion 53a, the second axial channel portion 53c, the first circumferential channel portion 53b, and the second circumferential channel portion 53d. The outflow port 59 is disposed at the end portion on the other side in the axial direction (−Y side) of the first axial channel portion 53a.

According to the present modification, as in the above-described embodiment, the second end channel 753 includes the first circumferential channel portion 53b, the second circumferential channel portion 53d, and the second axial channel portion 53c. Therefore, it is possible to uniformly cool the stator 40 around the outflow port 59 while securing the degree of freedom in arrangement of the outflow port 59.

According to the present modification, as in the above-described embodiment, since the second axial channel portion 53c is disposed between the pair of channel ports 58 and 59 in the circumferential direction, even if the pair of channel ports 58 and 59 is separated in the circumferential direction, the flow passage can be disposed without a gap, and the stator 40 can be uniformly cooled.

According to the present modification, as in the above-described embodiment, since the outflow port 59 is disposed between the first circumferential channel portion 53b and the second circumferential channel portion 53d in the central axis J1 direction, it is easy to dispose the flow passage around the outflow port 59 without a gap.

According to the present modification, a region A where no flow passage is disposed is disposed on the other side in the axial direction (−Y side) of the circumferential channel portion 752e of the first end channel 752. According to the present modification, when the motor housing 10 has the region A where the flow passage cannot be provided, the region A can be surrounded by the circumferential channel portion 752e, the second axial channel portion 53c, and the meander channel 51. As a result, the cooling of the region A can be promoted.

Further, according to the present modification, since the inflow port 58 is disposed in the circumferential channel portion 752e, the refrigerant W having the lowest temperature flows. Therefore, the cooling of the region A can be more effectively promoted by disposing the circumferential channel portion 752e adjacent to the region A in the axial direction.

The application of the drive apparatus to which the present invention is applied is not particularly limited. For example, the drive apparatus may be mounted on a vehicle for a purpose other than the purpose of rotating the axle, or may be mounted on a device other than the vehicle. The posture when the drive apparatus is used is not particularly limited. The central axis of the motor may be inclined with respect to the horizontal direction orthogonal to the vertical direction or may extend in the vertical direction. The features described above in the present description may be appropriately combined as long as no conflict arises.

For example, the number of housing members constituting the motor housing is not particularly limited. The motor housing may be configured by fixing two housing members to each other, or may be configured by fixing four or more housing members to each other.

Features of the above-described preferred embodiments and the modifications thereof may be combined appropriately as long as no conflict arises.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A rotating electric machine comprising:
a rotor configured to be rotatable about a central axis;
a stator surrounding the rotor; and
a motor housing accommodating the rotor and the stator,
wherein the motor housing includes:
a refrigerant channel through which a refrigerant flows; and
a pair of channel ports respectively located at both end portions of the refrigerant channel,
the refrigerant channel includes:
a meander channel extending in a wave shape along a circumferential direction; and
a pair of end channels connecting an end portion of the meander channel and the channel port, and
at least one of the end channels includes:
a first circumferential channel portion extending along the circumferential direction;
a second circumferential channel portion extending along the circumferential direction and overlapping the first circumferential channel portion as viewed in a direction of the central axis; and
an axial channel portion extending along an axial direction and connecting the first circumferential channel portion and the second circumferential channel portion.

2. The rotating electric machine according to claim 1, wherein the channel port is disposed between the first circumferential channel portion and the second circumferential channel portion in the direction of the central axis.

3. The rotating electric machine according to claim 1, wherein the axial channel portion is disposed between the pair of channel ports in the circumferential direction.

4. The rotating electric machine according to claim 1, wherein both of the pair of end channels include the first circumferential channel portion, the second circumferential channel portion, and the axial channel portion.

5. The rotating electric machine according to claim 1, wherein
one of the end channels has the first circumferential channel portion, the second circumferential channel portion, and the axial channel portion, and
the other of the end channels includes a third circumferential channel portion that directly connects the channel port and an end portion of the meander channel.

6. A drive apparatus comprising:
the rotating electric machine according to claim 1;
an inverter connected to the stator; and
an inverter housing that houses the inverter,
wherein one of the channel ports is connected to an inverter refrigerant channel provided in the inverter housing.

7. The drive apparatus according to claim 6, wherein the inverter housing is provided on a radially outer side of the motor housing when viewed from a direction of the central axis,
one of the channel ports overlaps the inverter housing in a radial direction, and
the other of the channel ports is disposed to be shifted from the inverter housing in the circumferential direction.

8. The drive apparatus according to claim 6, comprising a bus bar connecting the stator and the inverter,
wherein the end channel connected to the one of the channel ports and the bus bar at least partially overlap each other in an axial direction.
